(19) United States
(12) Patent Application Publication
(10) Pub. No.: US 2012/0193451 A1
(43) Pub. Date: Aug. 2, 2012

(54) DISPOSABLE CONTAINER FOR COLORED FLUID AND METHOD FOR PRODUCING SUCH A DISPOSAL CONTAINER

(76) Inventors: Hans Peter Sauer, Muelheim-Kaerlich (DE); Werner Neukirch, Andernach (DE); Jean-Pierre Martyn, Langenfeld (DE); Neil Remnant, Norwich Norfolk (GB)

(21) Appl. No.: 13/386,664

(22) PCT Filed: Jul. 15, 2010
(86) PCT No.: PCT/EP2010/060262

§ 371 Date: Apr. 5, 2012

(30) Foreign Application Priority Data
Jul. 23, 2009 (EP) 09009567.0
Sep. 4, 2009 (EP) 09169523.9

(51) Int. Cl. B05B 7/24; B65B 1/04

(52) U.S. Cl. 239/337; 53/467

(57) ABSTRACT

The invention relates to a disposable container for receiving and dispensing a coloured fluid by spraying, comprising a vessel which forms a storage volume for the coloured fluid and comprises a vessel base and a vessel wall, the vessel being closed by a cap, a pressure regulating unit which can be connected to a propellant reservoir being arranged on the cap, using which pressure regulating unit a propellant can be introduced into the storage volume in order to set therein a regulated overpressure relative to the environment, and a hose being arranged on the cap, via which hose a spray gun is connected to the storage volume.

The invention relates to a disposable container for receiving a coloured fluid and dispensing it by spraying, a method for producing a disposable paint container and the use of a container of this type for paint, varnish, glaze, wood preservative or similar fluids.

Disposable paint containers are known from the prior art, for example in the form of aerosol spray cans. In these cases, a coloured fluid and a propellant vessel under pressure are arranged in the can. An outlet valve is provided at the upper face of the can and when said valve is actuated, coloured fluid, which is pressurized by the propellant, can be sprayed via a spray nozzle provided at the valve.

When spraying the coloured fluid, the entire aerosol can is handled in order to dispense the coloured fluid onto a surface or an object in the desired manner. Aerosol cans of this type are therefore limited to sizes and filling volumes between usually 250 ml and 1000 ml. Handling is disadvantageously impaired or even impossible for aerosol spray cans of greater capacity. If a user wishes to dispense a correspondingly large amount of paint, he is forced to use a plurality of aerosol spray cans of this type, which leads to an increased amount of empty spray cans which must be recycled or disposed of, with corresponding environmental damage. Furthermore, known aerosol spray cans have the drawback that they must simultaneously be held in the hand and actuated, which is ergonomically disadvantageous and tiring, in particular when relatively large amounts of coloured fluid are to be dispensed.

Starting from the above-described prior art, the object of the invention is to provide a disposable container for receiving a coloured fluid and dispensing it by means of spraying, which container is easy to handle and transport even in the case of large container sizes, in particular in a range between 1 and 20 litres, can be used to spray even large amounts of paint ergonomically, can be used to store coloured fluid for prolonged periods of time without loss of quality, in particular even after a partial use, and finally can be disposed of or recycled effectively. The object of the invention is also to provide a method by which a disposable container of this type can be produced.

In terms of the device, the object is achieved by a disposable container for receiving a coloured fluid and dispensing it by spraying, comprising a vessel which forms a storage volume for the coloured fluid and comprises a vessel base and a vessel wall, the vessel being closed by a cap, a pressure regulating unit which can be connected to a propellant reservoir being arranged on the cap, using which pressure regulating unit a propellant can be introduced into the storage volume in order to set therein a regulated overpressure relative to the environment, and a hose being arranged on the cap, via which hose a spray gun is connected to the storage volume.

According to the invention, the spray gun and the vessel which forms the storage volume for the coloured fluid are not formed as a unit which is to be handled together when spraying coloured fluid. The use of a spray gun which is connected to the vessel via a hose makes it possible to provide vessels for large amounts of coloured fluid as disposable containers, it being possible during spraying of coloured liquid to place the vessel on the ground or on a corresponding surface and only actuate and handle the spray gun in a simple manner independently of the vessel and the weight thereof. During spraying of the coloured fluid, it is not necessary to move the entire vessel comprising the coloured fluid received therein, and this simplifies spraying and dispensing significantly.

In comparison to handling and actuating an aerosol spray can, handling and actuating a spray gun is an operation which is ergonomically more favourable and therefore can also be carried out for a longer period of time, in such a way that correspondingly large amounts of paint can be dispensed with less strain and fatigue. The spray gun can be formed in accordance with the shape, size and material of the vessel. It can therefore be adapted with greater freedom of design to the anatomy of the hand. It is preferably formed as an injection-moulded part, in such a way that it can be produced economically and simply in the corresponding shape at low weight.

Since the container according to the invention is conceived as a disposable container, it can be produced and distributed economically in comparison to reusable paint spraying systems or coating systems. Thus, it is also possible for occasional users to use a paint spraying system at comparatively low cost. It is particularly advantageous that cleaning, as is necessary in the case of professional reusable coating systems, is not necessary in this case and the disposable container can be disposed of completely or fed to a recycling process after emptying.

The disposable container advantageously consists of materials which can be disposed of or recycled effectively. For example, the vessel can consist of metal, preferably of tinplate or aluminium plate. Vessels of this type are sufficiently known and exhibit excellent resistance to reactive liquids which may be present, as well as ease of handling and storage. They are also suitable for recycling and exhibit excellent stability at a correspondingly low weight.

According to a further proposal, the cap can advantageously be configured as a plastics material component, in particular as a plastics material injection-moulded component. Plastics material is also very suitable as a recycling material. In injection moulding, the plastics material cap can be produced economically in virtually any shapes, it being possible in a particularly advantageous manner to use the pressure regulating unit in the form of a conventional plastics material assembly.

According to a further proposal of the invention, the cap is arranged in a substantially non-releasable manner on the vessel by the end user. In this way the tightness, operational reliability and safety of the disposable container can be ensured. In particular, the cap can be fastened to the vessel edge using locking members, for example in the form of a clip connection. Additionally or alternatively, fastening by means of gluing, welding, soldering or similar types of fastening is possible. It is particularly advantageous for the vessel edge to be bead-shaped or provided with a fold. The cap can be fixed on this bead or fold in an outwardly or inwardly overlapping manner by means of locking projections or clips. A further option for fixing the cap on the vessel involves the provision of a vessel cover on the side of the vessel wall opposite the vessel base. The vessel cover can be formed in one piece with the vessel wall or can be arranged thereon in a known, pressure-tight manner as a separate member. The vessel cover preferably consists of the same material as the rest of the vessel. A filling opening can be provided centrally in the vessel cover, through which opening the storage volume can be filled with coloured fluid and from which opening coloured fluid can be removed from the storage volume. This filling opening can then be used particularly advantageously, alone or in addition to the above-mentioned fastening, to fix the cap to the edge of the vessel in the same or a similar manner.

In a further embodiment it is provided that a riser tube which projects into the storage volume is arranged on the cap. This riser tube can be glued, inserted, screwed or connected to the cap in another way or formed in one piece therewith. The riser tube preferably has a tight flow connection to the hose and is used to receive coloured fluid from a region as close as possible to the base of the vessel and convey this fluid to the spray gun via the hose. In a particularly advantageous manner, the vessel base is curved, in such a way that a deepest point of the vessel is formed centrally or at the edge. The riser tube preferably ends at this deepest point or in the vicinity thereof, in such a way that it is possible to empty the disposable container almost completely.

According to a further proposal, it is provided that the riser tube projects through the filling opening and into the storage volume. Alternatively it is also possible to provide a separate opening in the vessel for the riser tube. Arranging the riser tube in the filling opening advantageously makes it possible for only one opening for filling and emptying to be provided in the vessel and for only this one opening to need to be sealed in a fluid-tight and pressure-tight manner. For this purpose a sealing plug, which is preferably made of rubber and which seals the gap between the riser tube and the edge of the opening in a fluid-tight and pressure-tight manner, can be arranged in the riser tube opening or filling opening between the riser tube and the edge, surrounding the opening, of the vessel. In terms of production it is particularly expedient for the sealing plug to be rigidly arranged on or connected to the riser tube. In particular, the sealing plug can be glued to the riser tube or integrally formed thereon. It is thus possible, when the cap is arranged on the vessel as intended, for the riser tube and the sealing plug to be arranged in the vessel opening in a sealing manner in one operation. The sealing plug can also initially be arranged as intended in the vessel opening and optionally held there by a positive locking, non-positive locking, integral formation or gluing. In this case, the riser tube is inserted into the sealing plug and optionally glued therein when the cap is arranged.

In addition to conveying the coloured fluid out of the vessel, the riser tube advantageously simultaneously fulfils the further function of feeding the propellant into the storage volume. The propellant is fed to the storage volume via the pressure regulating unit, it being possible in principle for the propellant outlet into the storage volume to be formed in any desired manner. However, if the riser tube is used for feeding propellant, then advantageously no further outlets and seals need to be provided for this purpose in the vessel or in the cap.

In addition to its function as a closure for the vessel, the cap closing the vessel simultaneously fulfils further functions. Thus, according to a further proposal of the invention, it can carry one or all of the units required for removing the coloured fluid, such as the pressure regulating unit, propellant reservoir, riser tube, hose, spray gun, as well as optionally provided safety and stop valves. It is particularly advantageous for the basic shape of the cap to correspond to the basic shape of the vessel. In the case of a substantially cylindrical vessel, which is particularly favourable in terms of production and logistics, the cap has a substantially circular basic shape. Its lower edge preferably has a slightly larger diameter than the edge of the vessel, on which edge the cap is arranged, in such a way that the cap can be arranged on the vessel such that it overlaps the vessel edge. It is particularly advantageous for the cap to be formed in such a way that, together with the vessel, it forms the disposable container in a shape which can be stacked and handled effectively. In the case of a, for example, cylindrical or barrel-shaped vessel, the cap can be formed in such a way that the entire disposable container is cylindrical or barrel-shaped. The overall shape, formed by the vessel and cap, of the disposable container then contributes to good stackability. On the side remote from the vessel, the cap can have an internal or external recess or groove. This recess or groove preferably extends annularly around the cap. The width and depth of the groove are preferably adapted to the length of the hose between the spray gun and the cap, in such a way that the hose can be coiled up into the recess or groove in a compact manner and so as to be largely protected from damage. It is particularly advantageous, according to a further proposal of the invention, when a seat for the spray gun arranged at the end of the hose is formed in or on the cap, in which seat the spray gun can be held, preferably by clamping or positive locking or by means of releasable holding means, in such a way that said spray gun can also be arranged in a secure manner on the cap so as to be protected from damage and incorrect actuation.

In order to facilitate transportation of the disposable container according to the invention and improve the ease of handling thereof, it is further proposed that one or more handles be provided on the cap. The handles are preferably formed on the side or end face of the cap remote from the vessel. A configuration of the handle in the form of grips shaped as segments of a circle is particular preferred, since handles of this type can form a limitation, which is peripheral at least in regions, on the side of the cap remote from the vessel.

In a further embodiment, the pressure regulating unit is arranged inside the cap or in a region which is limited outwardly by the cap. It is particularly advantageous for other functional units of the disposable container also to be arranged inside this region of the cap. The outwardly limited region can be formed by the cap itself, for example by the handle (handles) thereof and the structure comprising the recess or groove for the hose. The functional units of the disposable container arranged inside the region are received by the structure of the cap so as to be protected from damage.

In a particularly advantageous manner, the handle/handles are arranged in the form of a circle or segments of a circle parallel to the vessel base, in such a way that the basic structure of the disposable container consisting of the cap and vessel is substantially cylindrical, in such a way that disposable containers according to the invention can be stacked and stored particularly effectively and are transportable.

The use of a CO₂ cartridge as a propellant reservoir has proved particularly advantageous. The amount of CO₂ contained in the cartridge depends substantially on the internal pressure of the vessel required for spraying the coloured fluid and on the volume of the vessel. The use of a conventional 38 g CO₂ cartridge together with a 5 l vessel is particularly preferred. A vessel internal pressure of between 2.0 bar and 3 bar, preferably of 2.5 bar, depending on the spray nozzle used, has proved particularly advantageous. At a pressure of 2.5 bar, 5 l of coloured fluid can be sprayed by means of a conventional 38 g CO₂ cartridge. However, these values may vary as a function of the coloured fluid. Within the meaning of the present invention, a coloured fluid is to be understood to mean in particular paints, varnishes, wood preservatives, oils or similar liquids which must be dispensed by means of the spray nozzle in such a way that they are distributed as uniformly as possible. It should be noted that the spraying pressure, nozzle size and viscosity of the coloured fluid to be sprayed must be adapted to one another. Depending on the coloured fluid, other propellants can be used instead of CO₂. Examples in this case include nitrogen (N₂) or nitrous oxide (laughing gas, N₂O).

The invention further proposes a method for producing a disposable paint container for receiving a coloured fluid and dispensing it by spraying. The method is used in particular for producing the above-described disposable paint container in its various embodiments. In the method a vessel is provided which comprises a filling opening, for example in that it consists merely of a vessel base and a vessel wall or is additionally provided with a vessel cover comprising a filling opening. In the two embodiments the vessel can be produced as a semi-finished product by means of known production methods and can advantageously be made available as a semi-finished product of this type for example to a plant which produces paints. The vessel is filled with coloured fluid in a known manner via the filling opening. The filling process can take place by means of conventional filling machines either with the vessel in an upright position or by means of a filling lance. After filling, the filling opening is closed in a sealing manner. For this purpose a cap is fastened to the vessel, as described in connection with the above-described disposable paint containers. The cap is advantageously also formed as a semi-finished product and preferably provided with all the functional units which are necessary for operation of the disposable container. Thus, for example, a pressure regulating unit, which can be or is already connected to a propellant reservoir and using which a propellant can be introduced into the storage volume in order to set therein a regulated overpressure relative to the environment, is arranged on the cap as a semi-finished product. A hose, which in turn is connected at the end thereof opposite the cap to a spray gun, is preferably also arranged on the cap. It is particularly advantageous for the cap to be formed as a semi-finished product which already comprises all the functional units, since then during production of the disposable paint container the vessel which has been filled with coloured fluid merely needs to be closed by arranging the cap as intended and no further processing steps are required after filling. However, it is also possible to assemble one or more functional units only after the arrangement of the cap on the vessel. This may be expedient for example in the case of the propellant reservoir, since a malfunction or excessive pressurisation of the vessel after filling and before the actual removal of fluid is impossible when the propellant reservoir has not been assembled.

As described above, in one embodiment the cap is provided with locking members, in particular in the form of a clip connection, and can thus be fastened securely and durably in a particularly simple manner during assembly of the disposable paint container by placing the cap on the vessel and pressing. It is particularly advantageous when sealing means, which are necessary for sealing the filling opening of the vessel, are already pre-assembled or integrally formed on the cap, in such a way that no further processing steps are required prior to assembling the cap on the vessel, and the cap can be arranged, fastened and sealed to the vessel in one processing step.

Further features and details emerge from the following description of a non-limiting embodiment with reference to the figures, in which:

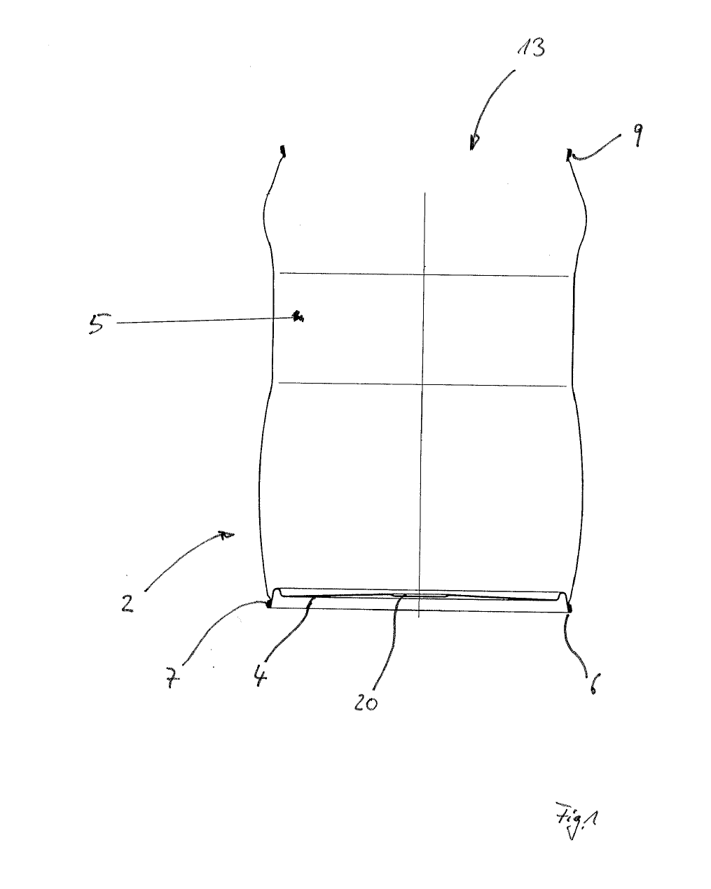

FIG. 1 shows a vessel for the disposable container in a first configuration,

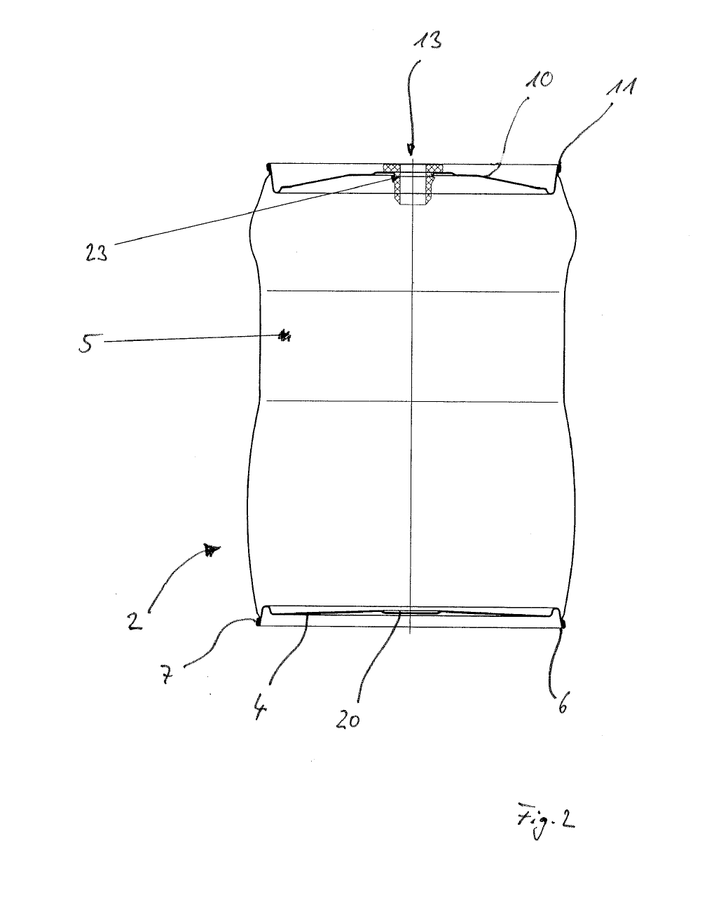

FIG. 2 shows the vessel for the disposable container in a second configuration,

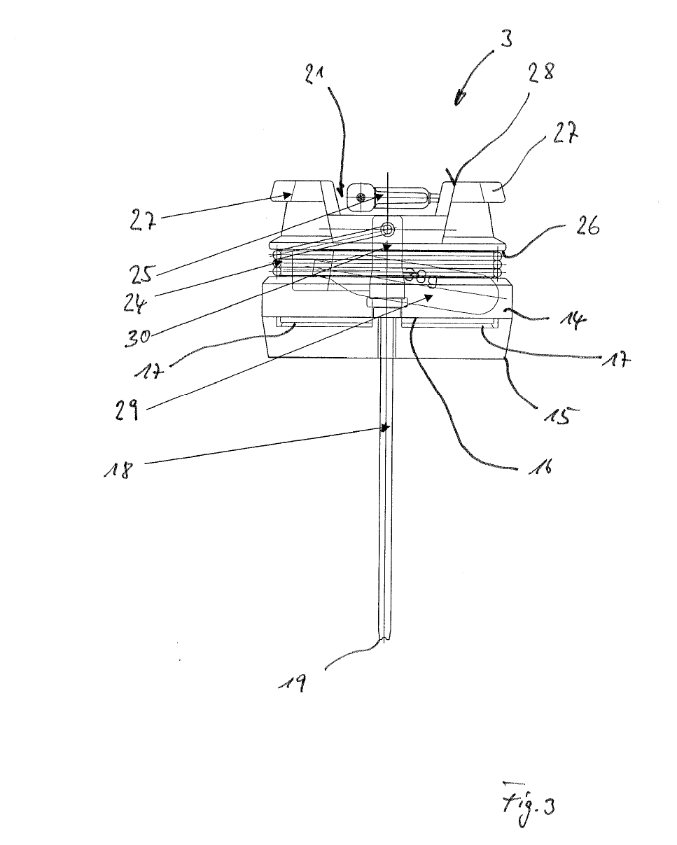

FIG. 3 is a schematic sectional view of a cap for the disposable container and

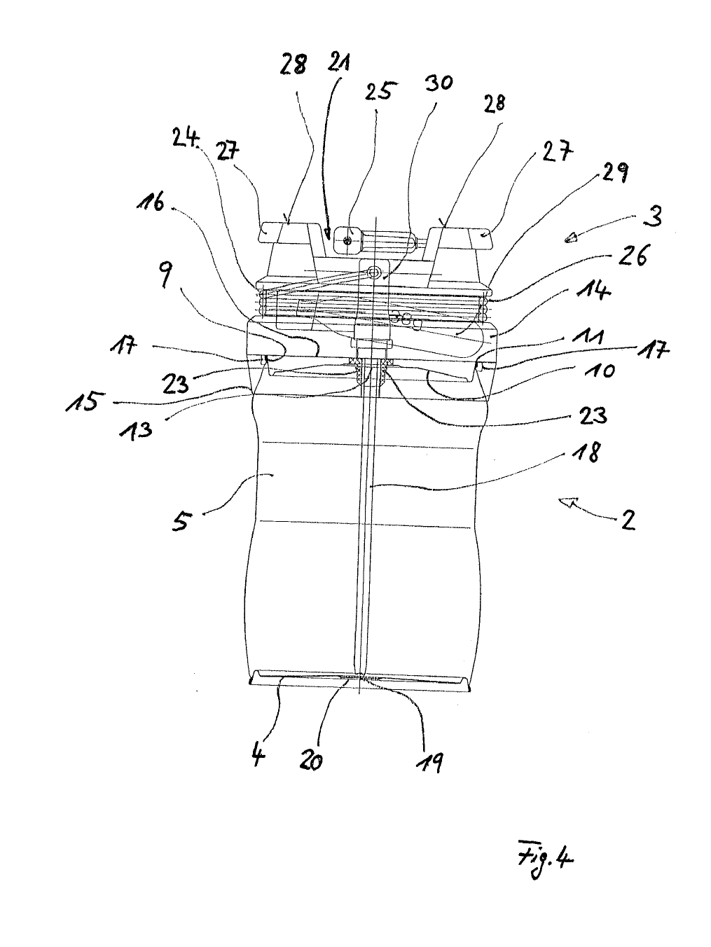

FIG. 4 shows the disposable container when filled and fully assembled.

FIG. 1 shows a vessel 2 for the disposable container 1 in a first configuration without an assembled cap 3. The vessel 2 comprises a substantially circular vessel base 4 and a vessel wall 5 connected thereto. In the inner region thereof, the vessel base 4 is curved towards the vessel interior. The outer edge 6 of the vessel base 4 thus forms an annular stand region on which the disposable container 1 can be stood in a safe and stable manner. The outer edge 6 comprises a fold 7 which is flanged outwardly and towards the vessel wall 5 and in which the outer edge 6 of the base 4 is received in a fluid-tight and pressure-tight manner. In the embodiment shown in FIG. 1, the substantially cylindrical vessel wall 5 ends, on the side remote from the vessel base 4, in an upper fold 9 formed by a flange. This fold stabilises the upper edge of the vessel wall 5 and also serves to fasten the cap 4, as described below.

In the alternative embodiment of the vessel 2 shown in FIG. 2, a vessel cover 10 is arranged on the side of the vessel wall 5 opposite the vessel base 4. In the inner region thereof, the vessel cover 10 is curved towards the vessel interior, in the same way as the vessel base 4, in such a way that a peripheral edge 11 of the cover is formed. Similarly to the vessel base 4, this edge is connected to the upper fold 9 of the vessel wall 5 in a fluid-tight and pressure-tight manner by a flange. The peripheral edge 11 of the cover forms a stand face on which the vessel 2 can be placed and stored as a semi-finished product or for filling by means of a filling lance. It is particularly advantageous for the shape of the vessel base 4 and of the outer edge 6 to be adapted to the shape of the vessel cover 10 and of the cover edge 11, in such a way that the vessel base 4 and vessel cover 10 of two vessels 2 stacked one on top of the other can engage in each other and partly around each other, in such a way that the vessels 2 can be stacked, stored and transported particularly effectively as a semi-finished product. A filling opening 13 is provided centrally in the vessel cover 10.

The cap 3 for the disposable container 1 is shown separately in a schematic side view in FIG. 3. The cap 3 comprises a main body 14. On the side which faces the vessel 2 when the cap 3 is arranged as intended, this main body is formed in accordance with the shape of the vessel, for example in a circular manner, and comprises an annular closing edge 15, the inner diameter of which is slightly greater than the outer diameter of the upper edge 11 of the cover, in such a way that the closing edge can engage around the vessel 2. The annular closing edge 15 sits on a disc-shaped cover region 16, in the centre of which the filling opening 13 is provided. Hook-like locking members 17 are provided on the inside of the annular closing edge 15, project from the cover region 16 towards the vessel 2 and, as can be seen from FIG. 4, engage around the edge 11 of the cover of the vessel 2 when the cap 3 is arranged as intended on the vessel.

is A riser tube 18, which is either integrally formed directly on the cover region 16 or is connected thereto in a sealing manner, is provided in the filling opening 13. As shown by FIG. 4, the length of the riser tube 18 is calculated in such a way that the open lower end 19 of the riser tube ends in a trough-like recess 20 of the vessel base 4. It is thus ensured that coloured fluid received in the vessel 2 can be removed substantially completely and without residue via the riser tube 18.

If the variant of the vessel 2 shown in FIG. 1 is used for the disposable container 1, sealing takes place between the cap 3 and the vessel 2 in the contact region between the upper fold 9 and the cover region 16. FIG. 4 shows the disposable container 1 comprising the variant of the vessel 2 which is shown in FIG. 2 and comprises a vessel cover 10 and filling opening 13. The riser tube 18 is guided through the filling opening 13. The sealing between the riser tube 18 and the vessel cover 10 is carried out via a plug 23 which is inserted into the filling opening 13 and surrounds the riser tube 18 in a fluid-tight and pressure-tight manner. In the two variants of the vessel 2, the cap 3 is fastened to the vessel 2 via the locking members 17 which engage around the edge 11 of the cover.

The riser tube 18 discharges into a hose 24. This hose connects the riser tube 18 to a spray gun 25. Coloured fluid drawn from the vessel interior via the riser tube 18 is guided through the hose 24 to the spray gun 25. The hose 24 is coiled up in a recess 26 formed on the outside of the cap 3 for transport and storage purposes and can be uncoiled for spraying the coloured fluid. Two opposing handles 27 in the form of segments of a ring are formed on the side of the cover region 16 opposite the annular closing edge 15. The end faces 28 of the handle 27 which are remote from the vessel 2 are planar and parallel to the plane of the outer edge 6, in such a way that a plurality of disposable containers 1 can be stacked one on top of the other by placing one disposable container 1 on another disposable container 2, it being possible for the outer edge 6 of the upper disposable container to engage around the handles 27 of the lower disposable container in such a way that a particularly stable state is made possible.

Further functional units are arranged in the inner region 21 of the cap 3, which inner region is defined by the handles 27, the recess 26 and the cover region 16. FIG. 4 shows that the spray gun 25 is arranged in this inner region 21 and is held by means of a clamping device (not shown). FIG. 4 also shows a CO₂ cartridge 29 filled with 38 g of CO₂ as a propellant. The CO₂ cartridge 29 is connected to the vessel interior via a pressure regulating valve 30 (shown only schematically in FIGS. 3 and 4). By means of the pressure regulating valve 30 it is provided that the desired overpressure continues to prevail during removal of the coloured fluid from the interior of the vessel 2, in such a way that a uniform spraying result can be achieved until the disposable container 1 is completely empty.

The spray gun 25 is formed as a disposable spray pistol in the form of a plastics material injection-moulded component. It comprises a stop valve (not shown in the figures) which can be actuated by means of a hand grip. For spraying coloured fluid received in the vessel 2, the vessel interior is pressurised via the pressure regulating valve 30 by means of CO₂ as a propellant from the CO₂ cartridge 29, in such a way that the desired and largely constant internal pressure for the removal is ensured. When the stop valve is opened by actuating the spray gun 25, coloured fluid contained in the vessel 2 under overpressure is sprayed out via the riser tube 18, the hose 24 and the spray gun 25.

### LIST OF REFERENCE NUMERALS

1 disposable container
2 vessel
3 cap
4 vessel base
5 vessel wall
6 outer edge
7 fold
8
9 (upper) fold
10 vessel cover
11 cover edge
12
13 filling opening
14 main body
15 closing edge
16 cover region
17 locking member
18 riser tube
19 end of riser tube
20 trough-like recess
21 inner region
22
23 plug
24 hose
25 spray gun
26 recess
27 handle
28 end face
29 pressurised CO₂ cartridge
30 pressure regulating valve

1. A disposable container for receiving a coloured fluid and dispensing it by spraying, comprising:
a vessel which forms a storage volume for the coloured fluid and comprises a vessel base and a vessel wall, wherein the vessel is closed by a cap; a pressure regulating unit which can be connected to a propellant reservoir being arranged on the cap, using which pressure regulating unit a propellant can be introduced into the storage volume in order to set therein a regulated overpressure relative to the environment; and
a hose via which a spray gun is connected to the storage volume being arranged on the cap.

2. The disposable container according to claim 1, characterised in that the cap is fastened to the vessel edge by locking members.

3. The disposable container according to claim 1, characterised in that at least one of:
the vessel is formed from metal, and;
the cap is a plastics material injection-moulded part.

4. The disposable container according to claim 1, characterised in that a handle for transporting the container is arranged on the cap.

5. The disposable container according to claim 1, characterised in that a recess is made in the outside of the cap, in which recess the hose can be coiled up for transport purposes.

6. The disposable container according to claim 1, characterised in that the pressure regulating unit is arranged in a region which is outwardly limited by the cap.

7. The disposable container according to claim 1, characterised in that the propellant reservoir can be arranged inside the region surrounded by the cap.

8. The disposable container according to claim 1, characterised in that the cap comprises a seat for the spray gun, in which seat the spray gun is held by clamping or positive locking.

9. The disposable container according to claim 1, characterised in that at least one of:
a CO₂ cartridge is fixed as the propellant reservoir on the pressure regulating unit;
the vessel has a storage volume of about 5 litres; and
an internal pressure of about 2.5 bar can be set in the storage chamber.

10. The disposable container according to claim 1, characterised in that a riser tube, which is connected to the hose and projects into the storage volume, is arranged on the cap.

11. The disposable container according to claim 10, characterised in that a vessel cover, in which a central filling opening is provided, is arranged on the side of the vessel wall opposite the vessel base.

12. The disposable container according to claim 11, characterised in that the riser tube projects through the filling opening and into the storage volume and the riser tube is sealed in the filling opening in a fluid-tight and pressure-tight manner by means of a sealing plug.

13. The disposable container according to claim 12, characterised in that the sealing plug is at least one of:
rigidly connected to the riser tube; and
integrally formed on the riser tube.

14. A method for producing a disposable paint container for receiving a coloured fluid and dispensing it by spraying, comprising:
providing a vessel comprising a filling opening;
filling the vessel with coloured fluid via the filling opening; and
closing the filling opening in a sealing manner by fastening a cap on the vessel, on which cap a pressure regulating unit is arranged which can be connected to a propellant reservoir and using which a propellant can be introduced into the storage volume in order to set therein a regulated overpressure relative to the environment, a spray gun which is connected to the storage volume being arranged on the cap via a hose.

15. The method according to claim 14, characterised in that the cap is a pre-assembled unit, wherein a CO₂ cartridge is arranged on the pressure regulating unit.

16. The method according to claim 14, characterised in that filling the vessel comprises filling the vessel with paint, varnish, glaze, or a wood preservative.

17. The disposable container according to claim 1, characterised in that the cap is fastened to the vessel edge by means of a clip connection.

18. The disposable container according to claim 5, characterised in that the recess is in the form of an annular groove.

19. The disposable container according to claim 9, characterised in that the CO₂ cartridge comprises a 38 g CO₂ cartridge.

20. The disposable container according to claim 13, characterised in that the sealing plug is glued to the riser tube.
